(19) United States
(12) Patent Application Publication
(10) Pub. No.: US 2012/0181815 A1
(43) Pub. Date: Jul. 19, 2012

(54) Reinforcement Arrangement for A Door Pillar of a Passenger Car and Method for Producing Such a Reinforcement Arrangement

(75) Inventors: Sascha Gentsch, Altenburg (DE); Engelbert Gramer, Eutingen (DE); Johann Seefried, Eutingen im Graeu (DE)

(73) Assignee: Daimler AG, Stuttgart (DE)

(21) Appl. No.: 13/498,650

(22) PCT Filed: Jul. 3, 2010
(86) PCT No.: PCT/EP2010/004042

§ 371 Date: Mar. 28, 2012

(30) Foreign Application Priority Data
Sep. 29, 2009 (DE) 10 2009 043 265.5

(51) Int. Cl. B60J 5/00; B21D 39/00; B23P 11/00

(52) U.S. Cl. 296/146.6; 29/897.2

(57) ABSTRACT

A reinforcement arrangement inside a cavity of a door pillar of a passenger car includes at least one reinforcement profile element, which is supported in a lower area by a support device of the reinforcement arrangement. The reinforcement profile element is reinforced in the area of the support device by an inner profile element arranged inside the cavity of the reinforcement profile element.

### BACKGROUND AND SUMMARY OF THE INVENTION

Exemplary embodiments of the present invention relate to a reinforcement arrangement inside a cavity of a door pillar of a passenger car and a method for producing such a reinforcement arrangement.

German Patents DE 10 2005 045 388 A1 or DE 10 2005 057 707 A1 disclose reinforcement arrangement provided inside the cavity of the respective door pillar, which is generally formed by sheet metal shell construction and therefore encloses said cavity so as, particularly in the event of the passenger car rolling over, to prevent excessive deformation or excessive buckling of the door pillar, the consequence of which being that a survival area for a passenger inside the passenger compartment of the passenger car would be excessively reduced.

Today typical reinforcement arrangements usually comprise a reinforcement profile element, for example, in the form of a reinforcement tube, which extends along the roof column area in the door pillar and in a lower area—particularly in the transition between the roof column area and a lower door pillar area running in vertical direction—is supported by means of a support device of the reinforcement arrangement. This support device, more particularly in the transition- or corner-area between the roof column area and the lower door pillar area of the door pillar, will ensure that the reinforcement profile element maintains its reliability and support accordingly.

Exemplary embodiments of the present invention are directed to a reinforcement arrangement and a method of producing such a reinforcing arrangement by means of which a particularly rigid and nevertheless especially weight-saving door pillar results.

In order to create a reinforcement arrangement, by means of which overall an especially weight-saving door pillar can be obtained, but which is supported extremely rigidly, according to the present invention the reinforcement profile element is reinforced in the area of the support arrangement by means of an inner profile element arranged inside the cavity of the reinforcement profile element. In other words, according to the invention the reinforcement profile element is strengthened inside that area, where this is supported downwardly by the support device. As a result of this simple, economic and nevertheless highly effective reinforcement of the reinforcement profile element by means of the inner profile element, a reinforcement arrangement is created in a simple manner, which is optimally adapted to the stresses incurred.

Thus, a reinforcement profile element can be used, which overall has a smaller wall thickness and/or a weaker profile in relation to the present state of the art, but which in the low stress areas is sufficiently rigid and stable and which in the higher stress areas—to be more exact in the area of the support on the support device—is reinforced accordingly by an inner profile element. Thus, overall greater rigidity of the reinforcement profile element at the same time with less weight can be obtained. Depending on the particular stress, optimal and economic adaptation to the calculation results of the door pillar can be achieved by the length and the contour of the inner profile element.

A particularly simple to produce reinforcement arrangement can be achieved by connecting the inner profile element only with a tight fit to the outside profile element. In other words, it is possible in a simple way in the case of the present embodiment to dispense with joints or the like for connecting the reinforcement profile elements to the inner profile element.

In a further advantageous embodiment the inner profile element is provided at least in the area of a support profile element of the support arrangement. Just in this area the reinforcement profile element incurs high stress, particularly in the event of the passenger car rolling over for example. Therefore, it is particularly advantageous to arrange the inner profile element in the area of this support profile element.

In a further embodiment of the invention the inner profile element at its ends comprises a straight or diagonal contour. By suitable selection of the contour, for example its angle, a corresponding mechanical value of the door pillar can be achieved in a simple way.

In a further advantageous embodiment the reinforcement profile element and the inner profile element are formed from respective semi-finished parts, whose cross sections are shaped after assembly and are connected together with a tight fit. In other words an advantageous embodiment results due to the semi-finished part of the reinforcement profile element and the semi-finished part of the inner profile element being first assembled and then shaped—for example by hydroforming—and thus connected together with a tight fit.

Alternatively, however, in another embodiment the reinforcement profile element and the inner profile element are formed from respective semi-finished parts, whose cross sections are shaped before assembly and adapted to each other, whereby the reinforcement profile element and the inner profile element are connected after assembly by further shaping—for example by bending along its longitudinal direction. In other words an at least radial positive connection of the reinforcement profile element and the inner profile element is thus already achieved as a result of the assembly, whereby axial locking of the inner profile element inside the reinforcement profile element is then ensured in the further shaping step.

### BRIEF DESCRIPTION OF THE DRAWING FIGURES

Further advantages, features and details of the invention result from the following description of preferred exemplary embodiments as well as on the basis of the drawings:

FIG. 1 illustrates a lateral view onto the reinforcement arrangement inside a cavity of a door pillar configured as A-column of a passenger car with a reinforcement profile element running particularly in a roof column area, which is supported by means of a support device in the transition area across a lower door pillar area of the door pillar, whereby the support device comprises a triangular sheet metal construction with two partial shells as well as more particularly a support profile element, and whereby the reinforcement profile element is reinforced by means of an inner profile element arranged inside the cavity of the reinforcement profile element in the area of the support device or the support profile element;

FIG. 2 illustrates a lateral view onto the reinforcement arrangement in FIG. 1, whereby a partial shell of the support device is omitted, so that the support profile element, which extends substantially inside the door pillar area of the door pillar and which is fastened to the reinforcement profile element in a corner area between the roof column area and the door pillar area of the door pillar, is evident, the inner profile element being arranged in the area of the connection point of the support profile element on the reinforcement profile element again inside the reinforcement profile element;

FIGS. 3a, 3b illustrate respective lateral views onto the reinforcement profile element as well as in particular the support profile element of the support arrangement, the inner profile element being arranged in the connection area of the support profile element on the reinforcement profile element inside said reinforcement profile element, the inner profile element in FIG. 3a at its respective ends comprising a straight contour and in FIG. 3b at its respective ends comprising a diagonal contour;

FIG. 4 illustrates five schematic lateral views of the open reinforcement profile element inside the roof column area as well as the inner profile element of the support device running inside the door pillar area, the respective inner profile element of the reinforcement profile element being arranged at the connection point of the inner profile element on the reinforcement profile element and the inner profile element at its respective ends comprising a straight or diagonal contour; and

FIG. 5 illustrates an overview over two variants of the connection of the inner profile element with the reinforcement profile element, whereby on the left in a first variant the reinforcement profile element and the inner profile element are formed from respective tubular semi-finished parts, whose cross sections are already shaped before assembly, as a result of which a tight fit results in radial direction, and whereby the inner profile element is fixed with a tight fit in axial direction inside the reinforcement profile element, by connecting the reinforcement profile element and the inner profile element together in a further shaping process by bending and whereby, in accordance with the variant on the right, respective tubular hollow cross sections are selected, which initially are not connected together with a tight fit and which are only connected together with a tight fit after assembly both in radial as well as in axial direction due to these being shaped together accordingly.—

### DETAILED DESCRIPTION

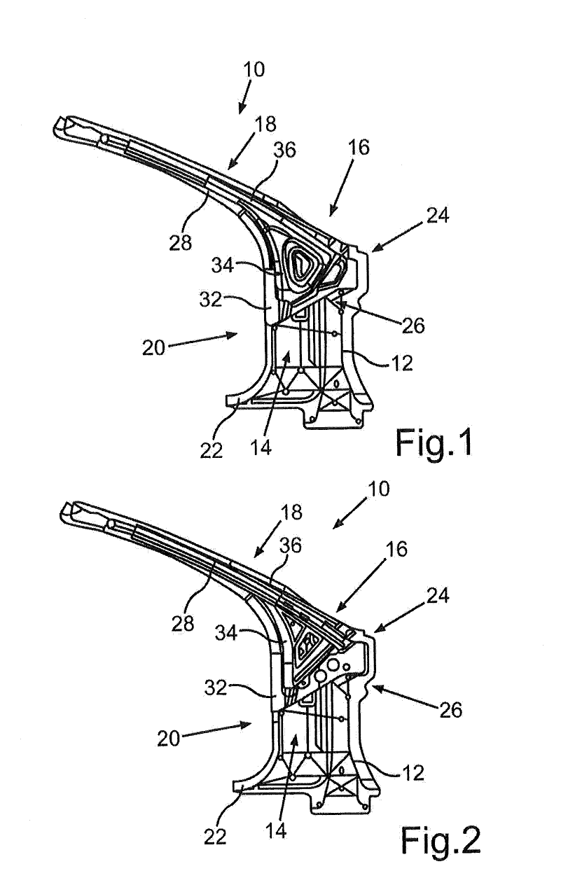

In FIGS. 1 and 2 a door pillar 10 is illustrated in the form of an A-column of an open passenger car in lateral view in each case. To be more exact only a partial shell 12 made, for example, of sheet metal or the like, which is assembled with a second (not illustrated) partial shell while forming a cavity 14, is illustrated. A reinforcement arrangement 16, evident in FIGS. 1 and 2 which, particularly in the event of the open passenger car rolling over, will prevent the respective door pillar 10—more exactly its roof column area 18—from being excessively buckled or bent in towards the vehicle floor, so that a survival area of the passengers can no longer be assured, is fastened inside the cavity 14 of the door pillar 10. On the contrary the reinforcement arrangement 16 will ensure that the roof column area 18 of the door pillar 10 is not bent—at least not excessively—in the downward direction or towards the passenger compartment.

Apart from the roof column area 18 the door pillar 10 comprises a door pillar area 20 with a column root 22, which extends downwards from a corner area or a transition area 24 at the lower end of the roof column area 18.

A support device 26 of the reinforcement arrangement 16, which supports a reinforcement profile element 28 or the roof column area 18 of the door pillar 10 against excessive movement towards the passenger compartment in the event of impact force caused by an accident, is provided in this transition area 24 of the cavity 14 of the door pillar 10.

The reinforcement profile element 28 extends substantially over approximately the entire length of the roof column area 18 of the door pillar 10 inside its cavity 14. The reinforcement profile element 28, which in this case is formed as reinforcement tube, terminates towards the front, roughly at the front end of the transition area 24 in the door pillar area 20 of the door pillar 10.

The support device 26 more particularly comprises a support profile element 30 in the form of a support tube, which substantially extends inside the door pillar area 20 of the door pillar 10 and therefore is at angle with the reinforcement profile element 28. Both the reinforcement profile element 28 and the support profile element 30 in this case are configured slightly curved.

Furthermore, the support device comprises a plurality of sheet metal shell elements 32, 34, whereby in contrast to FIG. 1, the front—in the viewing direction—sheet metal shell element 34 has been omitted in FIG. 2 for the sake of clarity, particularly of the support profile element 30.

The sheet metal shell elements 32, 34 in the present case form an approximately triangular structure, which additionally reinforces the profile elements arranged at an angle to each other—the reinforcement profile element 28 and the support profile element 30—with respect to their mutual connection. The sheet metal shell elements 32, 34 are likewise held and fastened inside the cavity 14 of the door pillar, so that overall an extremely stable support device 26 results, by means of which the reinforcement profile element 28 is widely supported in the transition area 24 between the roof column area 18 and the door pillar area 20 of the door pillar 10.

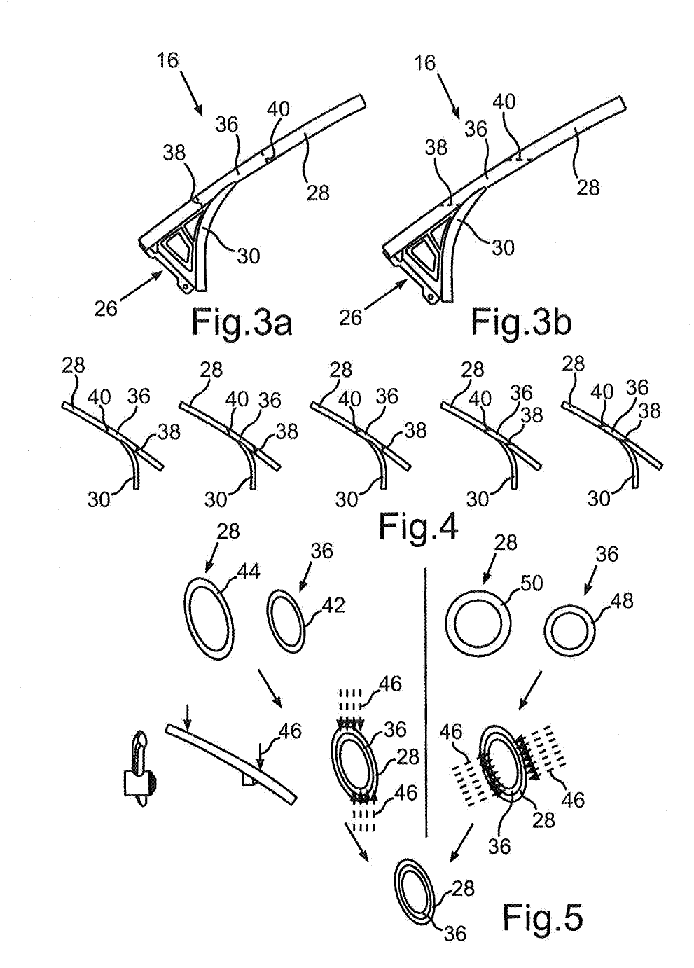

In conjunction with FIGS. 3a and 3b it is evident how the reinforcement profile element 28 and the support profile element 30 of the support device 26 are connected together or in what way the corner area between the two profile elements is reinforced by means of the corresponding sheet metal shell element. The two profile elements depicted in isolation—the reinforcement profile element 28 and the support profile element 30—are illustrated in this case without the other components of the door pillar 10 or the support device 26. In addition these are shown mirrored relative to FIGS. 1 and 2.

From FIGS. 3a and 3b it is now especially evident that the reinforcement profile element 28, which is formed as tubular profile element, is reinforced in the area of the support device 26—particularly in the area of the support profile element 30—with an inner profile element 36 arranged inside the cavity of the reinforcement profile element 28. This inner profile element 36 in this case is an inner tube, which extends over a partial length of the reinforcement profile element 28, and to be precise in the area of the connection point of the support profile element 30 on the reinforcement profile element 28.

While with the embodiment in FIG. 3a the inner profile element at its respective ends 38, 40 comprises a straight or vertical contour, with the embodiment in FIG. 3b the respective ends 38, 40 are cut diagonally. Here the angle of the two contours is selected so that these run substantially horizontally.

FIG. 4 shows, respectively, in lateral view five possible shapes of the inner profile element 36 which, in the area of the connection point of the support profile element 30, are always arranged on the reinforcement profile element 28 inside its cavity. The extreme left illustration, similarly to the embodiment in FIG. 3a, again shows respective straight or vertical contours 38, 40 at the corresponding ends of the inner profile element 36. With the second variant of the inner profile element 36, contours running parallel to each other are provided at its ends 38, 40, whereby the two contours run at an angle of 60° relative to the longitudinal direction of the reinforcement profile element 28. In the middle illustration the ends 38, 40 of the inner profile element 36 are cut in such a way that in each case these are at an angle of 45° relative to the longitudinal direction of the reinforcement profile element 28 or the inner profile element 36. The two contours at the ends 38, 40 in this case do not run parallel to each other. In contrast to this the second embodiment, seen from the right, shows respective contours likewise relative to the longitudinal direction of the inner profile element 36 or the reinforcement profile element 28 in each case of 45°, whereby these run parallel to each other in contrast to the middle illustration. Finally, the extreme right illustration at the ends 38, 40 of the inner profile element 36 shows respective contours relative to the longitudinal direction of the inner profile element 36 or the reinforcement profile element 28 in each case of 60°, whereby the two ends 38, 40 run parallel to each other and in contrast to the second illustration, seen from the left roughly in horizontal direction, while the contours in the second illustration on the other hand run seen from the left in vehicle vertical direction.

It should be recognized that the present invention can also employ straight or diagonal contours. Also, it is possible to provide at an end 38 a straight or vertical contour of the inner profile element 36 relative to its longitudinal direction while at the other end 40 a corresponding diagonal contour relative to the longitudinal direction of the inner profile element 36 can be provided—or vice-versa.

The function of the inner profile element 36 is especially so that the reinforcement profile element 28 can be reinforced specifically at that place, where particularly in the event of impact force caused by an accident the highest stresses are incurred. The critically stressed area of the reinforcement profile element 28 in the present case is the support place, where the reinforcement profile element 28 rests on the support device 26 with the support profile element 30. As a result of the inner profile element 36 this higher stressed area can be reinforced extremely advantageously, while, for example, an upper end of the reinforcement profile element 28, by contrast, manages with a smaller wall thickness and therefore less weight. Thus, it is clear that a reinforcement arrangement 16, which comprises a particularly advantageous rigidity especially of the reinforcement profile element 28 and nevertheless of extremely weight-saving construction, can be created in a simple way by means of a corresponding inner profile element 36. Depending on the stress incurred an optimal and economic adaptation to the calculation results can be achieved by the length and the contour of the inner profile element 36, which in this case is formed as inner tube. In particular, by providing diagonal contours or ends 38, 40, a particularly harmonious wall thickness transition can be obtained. It should be noted that the contour described above is not necessarily understood to mean machining in this sense. It would also be conceivable that the inner profile element 36 is not cut accordingly or similarly mechanically processed but that for example it concerns a casting or a plastic component. In this case however the tube was cut to length accordingly.

Finally FIG. 5 illustrates two possible methods, wherein the inner profile element 36 can be joined to the reinforcement profile element 28:

The left illustration shows a method, wherein a semi-finished part 42 of the inner profile element 36 and a semi-finished part 44 of the reinforcement profile element 28, which in cross section already exhibit their final cross-section shape, are used. The cross-section shape, here selected oval, of the hollow section 44 of the reinforcement profile element 28 with respect to its inner circumference is adapted in form to the outer circumference of the semi-finished part 42 of the support profile element 30. Thus, a tight radial fit between the two semi-finished parts 42, 44 already results on being assembled. In other words, the two semi-finished parts 42, 44 were already shaped before assembly. After assembly the semi-finished parts 42 and 44 were then mutually locked also in longitudinal direction or axial direction, by corresponding longitudinal bending of the two profile elements—as indicated by the arrows 46. As a result of this further shaping the reinforcement profile element 28 and the inner profile element 36 are then mutually fixed both radially and axially.

In the production method indicated in FIG. 5 on the right, two semi-finished parts 48, 50, which in contrast to the left exemplary embodiment, wherein these have an oval cross section, profile elements each with a circular or annular cross section are initially used. In the present exemplary embodiment the inner diameter of the semi-finished part 50 of the reinforcement profile element 28 is selected in such a way that this is adapted with a tight fit to the outer circumference of the semi-finished part 48 of the inner profile element 36. This, however, is not absolutely necessary. The two semi-finished parts 48, 50 are then shaped after assembly in a process step and thus connected together with a tight fit. Apart from conventional shaping processes, hydroforming can also be employed. In the end a connection arrangement of the two profile elements—the reinforcement profile element 28 and the inner profile element 36—is achieved in every case, wherein the two components are fixed in their mutual position and to be precise without further joining techniques. It should be recognized that the present invention can employ other methods of connection, for example, joining or mechanical means could also be used. The present methods of connection however in particular offer the advantage that both semi-finished parts 42, 44 or 48, 50 can be joined together in an extremely simple way and without elaborate processing. Therefore, a welding process, which might reduce the tensile strength and the rigidity of the corresponding steel due to thermal stress, can be dispensed with. Rather in this case force, indicated by the arrows 46 in the form of bending or pressing force, is used to join the two semi-finished parts together.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-9. (canceled)

10. A reinforcement arrangement inside a cavity of a door pillar of a passenger car, comprising:
a reinforcement profile element; and
a support device configured to support the reinforcement profile element in a lower area of the reinforcement profile element,
wherein the reinforcement profile element is reinforced in the area of the support device by an inner profile element arranged inside a cavity of the reinforcement profile element.

11. The reinforcement arrangement according to claim 10, wherein the inner profile element is arranged at least inside an area of a support profile element of the support device.

12. The reinforcement arrangement according to claim 10, wherein ends of the inner profile element have a straight or diagonal contour.

13. The reinforcement arrangement according to claim 10, wherein the reinforcement profile element and the inner profile element are formed from respective semi-finished parts, whose cross-sections are shaped after assembly and are connected together with a tight fit.

14. The reinforcement arrangement according to claim 10, wherein the reinforcement profile element and the inner profile element are formed from respective semi-finished parts, whose cross-sections are shaped before assembly, wherein the reinforcement profile element and the inner profile element are connected together with a tight fit after assembly by further shaping.

15. A method for producing a reinforcement arrangement inside a cavity of a door pillar of an open passenger car, the method comprising:
arranging a reinforcement profile element so that a lower area of the reinforcement profile is supported by a support device of the reinforcement arrangement,
wherein the reinforcement profile element inside the area of the support device is reinforced by an inner profile element arranged inside a cavity of the reinforcement profile element.

16. The method according to claim 15, wherein ends of the inner profile element have a straight or diagonal contour.

17. The method according to claim 15, wherein the reinforcement profile element and the inner profile element are formed from respective semi-finished parts, whose cross-sections are shaped after assembly and connected together with a tight fit.

18. The method according to claim 15, wherein the reinforcement profile element and the inner profile element are formed from respective semi-finished parts, whose cross-sections are shaped before assembly, wherein the reinforcement profile element and the inner profile element are connected together with a tight fit after assembly by further shaping.
